(19) United States
(12) Patent Application Publication
(10) Pub. No.: US 2005/0189413 A1
(43) Pub. Date: Sep. 1, 2005

(54) Store layouts

(76) Inventors: John Turek, Indianapolis, IN (US); Joseph Milosheff, Elgin, IL (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 11/068,073

(22) Filed: Feb. 28, 2005

Related U.S. Application Data
(60) Provisional application No. 60/548,315, filed on Feb. 27, 2004.

(51) Int. Cl. G06K 15/00

(52) U.S. Cl. 235/383

(57) ABSTRACT

A store for selling merchandise to customers, with a central, substantially open, area having a ceiling of a given height, and providing a place for merchandise. For example, a plurality of departments for merchandise surround the central area, the merchandise departments being connected to the central area and to each other in a manner permitting free flow of customers between merchandise departments and the central area. As an optional feature, the merchandise departments each have a height less than the height of the central area. In certain embodiments, a perimeter customer path around the central open area and an additional customer path through the merchandise departments provide flexible traffic flow.

### FIELD OF THE INVENTION

The present invention relates to the field of stores, for example grocery stores, for selling merchandise to customers.

### BACKGROUND OF THE INVENTION

The business of merchandising to both trade and retail customers has seen a significant evolution over the past decade. Because of the growth of large national and international marketing organizations, there has been a trend to ever-larger stores. In the past, a large store would be one having 30,000 sq. ft. of floor space. Now, a typical large store has upwards of 60,000 sq. ft. floor space. The reason this is necessary is to make sufficient quantities and sufficient varieties of goods available for purchase. Along with this increase in size has been a trend towards interior spaces fashioned along the lines of warehouses or “big box stores” where there is an enormous continuous high ceiling building with elongated and elevated rows to pack a maximum amount of merchandise into the space. Typically, such arrangements called for aisles or rows that extend almost to the perimeter of the building. A consequence of this is that a customer is forced to traverse a serpentine path through the store along aisles that can reach lengths of 100 feet. Customers would prefer a less time intensive arrangement.

Added to the problem of long aisle lengths for a customer to travel is the sometimes counter-intuitive grouping of merchandise within stores. As an example, in some supermarkets a person will purchase sliced meats in the delicatessen section and packaged meats in the meat department. Another example is that cheese to be sliced is found in the delicatessen and the packaged cheese is found in the dairy department. Still a further example is that raw materials for baking will be found in the baking section, pastry will be found in another section and bread will be found in yet a third section. This grouping of merchandise has largely evolved because of ordering responsibilities within a supermarket. While this arrangement preserves the existing selection and distribution responsibilities, it does little to provide a rewarding and pleasant environment for a customer. The current grouping of merchandise compounds the drain on a customer's time because not only can the customer go to the wrong location for their goods, they must travel great distances to find the correct goods and make the selection.

Thus, there exists a desire to provide an improved store configuration.

### SUMMARY OF THE INVENTION

Certain selected embodiments relate to a store for selling retail merchandise for customers in which a central substantially open area is provided for a place for merchandise. The central area has a ceiling of a given height and is surrounded by a plurality of merchandise stations. The merchandise stations are covered with a ceiling having a height lower than the central area and are connected to the central area and to each other in manner that permits free flow of customers between the merchandise stations and the central area.

In one option, the store has a perimeter customer path around the central area, the merchandise stations are departments and a second customer path is provided substantially through the merchandise departments that surround the central area.

In an alternative embodiment, the store has display shelves along department walls that are standard height and displays in the center having a lower height.

In another aspect of certain embodiments, the merchandise stations and departments have easily visible identifying signs.

In yet other embodiments, aisles for merchandise in the departments, stations, and central area are of reduced length.

### BRIEF DESCRIPTION OF THE DRAWINGS

FIG. 1 is a simplified floor plan of a store illustrating one embodiment.

FIG. 1A is a partial elevational view of the store of FIG. 1, taken on lines 1A-1A of FIG. 1.

FIG. 2 is a simplified floor plan of a store showing an alternate embodiment.

FIG. 2A is a plan view showing another store layout.

FIG. 2B is a plan view showing still another store layout.

FIG. 3 is a floor plan of a central area that may be employed in the stores of FIGS. 1, 2, 2A and 2B.

FIG. 4 is an elevation view of one wall of the central area of FIG. 3 taken on lines 4-4 of FIG. 1.

FIG. 5 is the floor plan of a merchandise department of FIG. 1.

FIG. 6 is a fragmentary elevational view of the department of FIG. 5 looking into the department from the central area taken on lines 6-6 of FIG. 5.

FIG. 6A is a fragmentary elevational view of the department of FIG. 5 taken on lines 6-6A of FIG. 5.

FIG. 7 is a fragmentary elevational view in the department shown in FIG. 5, looking into an adjacent department and taken on lines 7-7 of FIG. 5.

FIG. 8 is a fragmentary elevational view from an adjacent department looking into the department of FIG. 5 and taken on lines 8-8 of FIG. 5.

### DESCRIPTION OF SELECTED PREFERRED EMBODIMENTS

For the purposes of promoting an understanding of the principles of the invention, reference will now be made to the embodiments illustrated herein and specific language will be used to describe the same. It will nevertheless be understood that no limitation of the scope of the invention is thereby intended. Any alterations and further modifications in the described processes, systems or devices, and any further applications of the principles of the invention as described herein, are contemplated as would normally occur to one skilled in the art to which the invention relates.

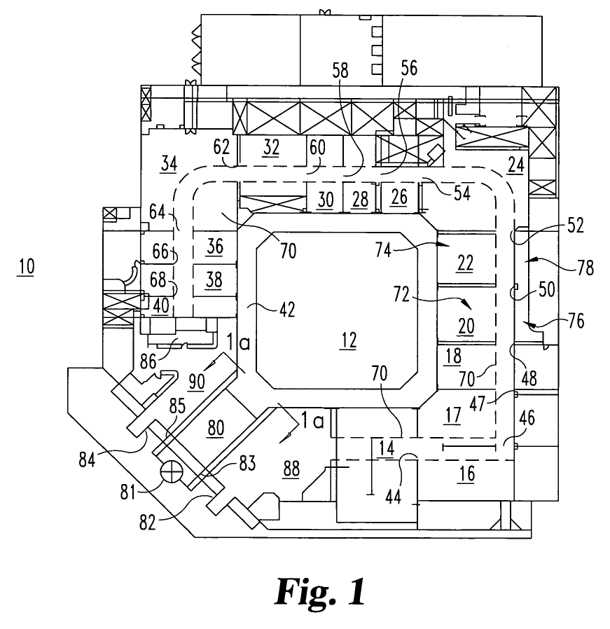

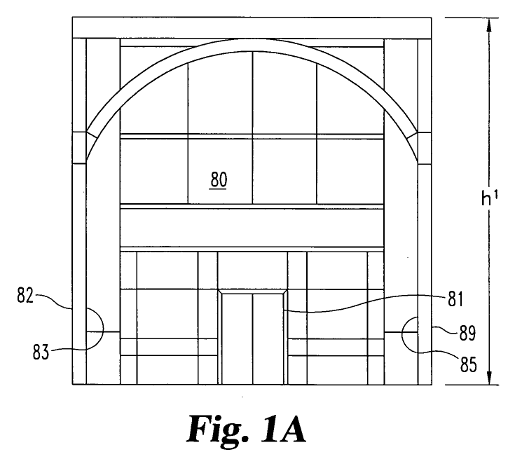

Referring to FIG. 1, there is shown a store for merchandise generally indicated by reference character 10 and having a central open area 12 surrounded by a plurality of departments 14, 16, 17, 18, 20, 22, 24, 26, 28, 30, 32, 34, 36, 38 and 40. An entry 80 and checkout area 88 and 90 complete the perimeter of the central open area 12. It should be apparent to those skilled in the art that the departments 14 through 38 may be arranged in any one of a number of sequences to provide a most efficient and pleasant customer experience, and still follow the principles of the present invention.

One feature of certain embodiments is to make a large store on the order of warehouse type stores appear to be smaller stores. This is done by minimizing the distance to the furthest wall observable by a customer. Thus, the central open area 12 may have a high ceiling, but the individual merchandise departments have lower ceilings, giving customers the feeling and impression of a much smaller store. The relationship between the central area 12 and the individual departments 14 through 40 will be discussed in detail later.

Optionally, entryways are provided between open area 12 and the individual departments 14 through 38 so that the distance from any one department to another is significantly minimized, thus reducing the apparent size of the store. In furtherance of the improved traffic pattern, the central open area 12 has a perimeter customer aisle or path 42 surrounding the central open area. Within the inner bounds of the perimeter path 42, merchandise can be arranged in a flexible pattern depending upon the needs of the particular store. Thus it is seen that a customer can easily traverse the path 42 from one department to another. Although not shown in the schematic drawing of FIG. 1, preferably each individual department has an opening into the central open area 12, initially through the perimeter customer path 42.

In certain embodiments, in addition to the customer path 42 around the perimeter of the central open area 12, there is provided an additional customer path through departments 14 through 40 for example by archways 44 through 68. The outer customer path 70 provides a second path for a customer to traverse the store from one department to the next. As illustrated, the archways 44 through 68 define an outer customer path, loosely defined by dashed lines 70. It should be noted that the sequence of the numbers and the arrangements of the departments are in a counter-clockwise fashion since customers often immediately proceed to the right when they go into the store. It should be apparent to those skilled in the art that the traffic pattern is capable of bi-directional movement.

The outer customer path 70 provides a dual function. It permits customers to collect their thoughts and plan which merchandise to purchase as they traverse path 70. Some departments 14 through 38 have simply merchandise items for sale. Other departments within this group have merchandise as well as a customer counter. By way of example, department 14 may be a delicatessen having primarily customer service and department 38 may be a baby department having only merchandise. Departments 20 and 22 may be configured to provide merchandise display areas 72 and 74 and customer assistance counters 76 and 78 respectively. It should be noted that providing the outer customer path 70 between the merchandise display areas 72 and 74 and counters 76 and 78 enables space for customers to queue for service as well as to determine merchandise they wish to purchase. It should be apparent that the exact sequence of the departments can be varied according to individual store needs without departing from the spirit and scope of the present invention.

In FIG. 1, the checkout and entry area is shown as located on the diagonal of an approximate square defining the outer perimeter of the building 10. Thus, an entry 80 provides a path into the central open area 12, initially crossing the perimeter customer path 42. As shown in FIG. 1A, entry 80 has substantially the same ceiling height as that for the central area 12 (described below) providing an expansive area leading from the entry door 81 to the interior central open area 12. Entry area 80 is sufficiently wide to permit a range of additional merchandise to be displayed, for example, floral items. Exit from the store is through opposed doors 82 and 84 flanking the entry 80. Hallways 83 and 85 extend from adjacent exits 82, 84, respectively to entry 80 so as to provide a ready circulation of shopping carts. A customer service area 86 is provided and checkout areas 88 and 90 flank the entry area 80 and are adjacent the exit doors 82 and 84. Checkout areas 88 and 90 can employ a variety of self-service or operator assisted checkout devices. In one feature, with the location of a delicatessen area 14 adjacent checkout area 88, a customer can go through an extremely short loop to purchase and checkout delicatessen items.

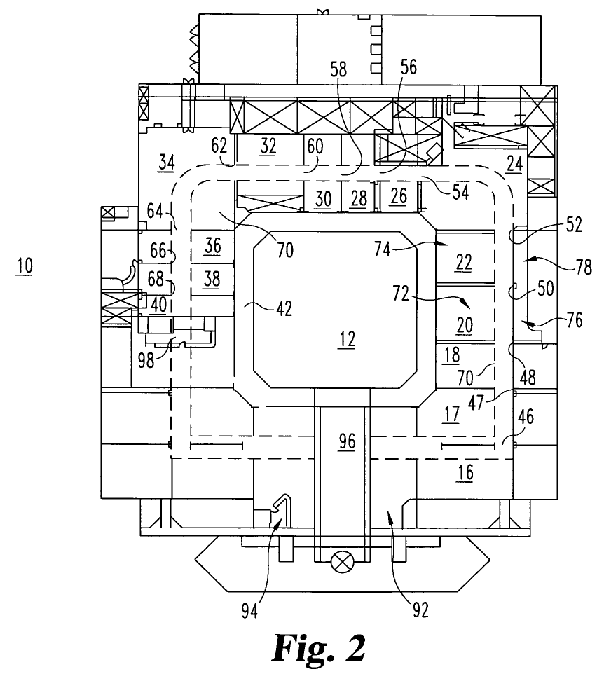

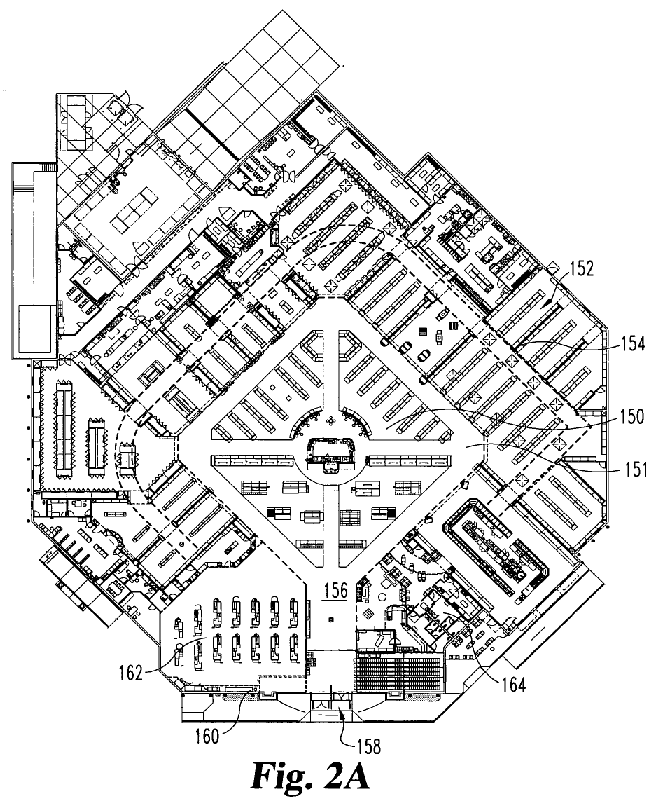

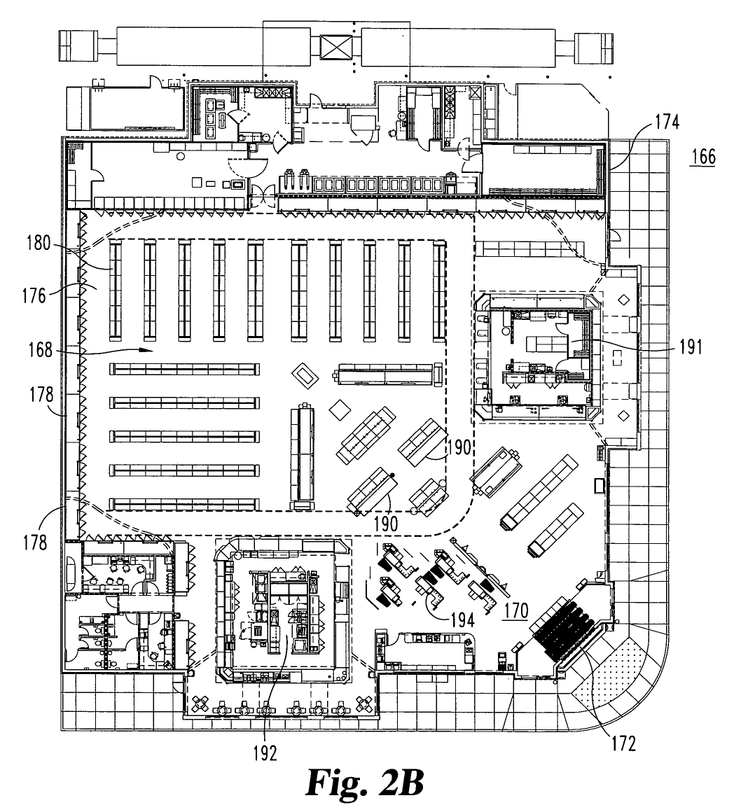

The arrangement of FIG. 1 shows the entry and exit areas on the diagonal of the central area 12 and on one corner of building 10. The arrangement of FIG. 2 shows an alternative arrangement which includes departments surrounding the central open area 12, but with an entry/exit area located on one side wall of the central open area 12 and in the middle of one of the outer walls of the generally square shape of the building 10. In order to minimize proliferation of numbers, the departments not affected by the alternate location of the entry/exit will be given the same numbers. The sequence and character of merchandise within the department may be altered to provide efficient circulation by customers and selection of merchandise. The arrangement of FIG. 2 includes checkout areas 92 and 94 flanking an entryway 96 which leads from the exterior of the store 10 to the interior open area 12 past the perimeter customer path 42. A customer service area 98 is provided adjacent checkout area 94. It should be noted that the perimeter customer path 42 and outer customer path 70 can be employed with this floor arrangement to provide equivalent benefit of circulation and convenience of selection.

FIG. 2A shows yet still another alternate embodiment of the store arrangement of FIG. 1. In this embodiment a central open area 150 is surrounded by a plurality of departments 152. A pathway shown by dashed lined 154 provides an outer customer path in addition to the perimeter path or aisle 151 around central area 150. The exit/entry area 156 extends diagonally from the corner of one of the sides of the central area 150 to an entry and exit vestibule 158. Entry area 156 has substantially the same height as central area 150 which has a height greater than those for the peripheral departments. The entry and exit vestibule 158 is located along a wall 160 providing a flattened area for ease of parking. In this embodiment all the cashier stations 162 are located to one side of the entry and exit vestibule and a cafe 164 is located to the opposite side of the entry/exit vestibule. This arrangement also has the ability to provide flow around the central area 150 by means of the peripheral path 151 and through department 152 by means of dashed lines 154.

FIG. 2B shows still another embodiment showing the application to a smaller sized store. A store for merchandise is designated as 166 and comprises a central open area 168 with an entry/exit area 170 extending to a diagonal of the central open area. The store has an entry/exit vestibule 172 on the corner of the outer walls 174 of the building 166. The outer walls 174 define an approximate rectangular shape. A peripheral aisle 176 shown by dashed lines extends around the central open area 168. In this arrangement, a plurality of merchandise stations 178 are positioned around at least a portion of the periphery of the central open area 168. The central open area has a plurality of merchandise stands 180 configured for convenient display of merchandise and a plurality of merchandise stands 190, preferably for displaying produce, which are elongated and at approximately right angles to the path of customers coming into the store. A delicatessen department 191 is located to one side of the entry way and a bakery department 192 is located on the opposite site of the entryway. Cashier stations 194 are located adjacent the entry passageway 170. Thus it is seen that the store shown in FIG. 2B embraces the core principles of customer flow and providing limited sight distances to reduce the apparent size within the store.

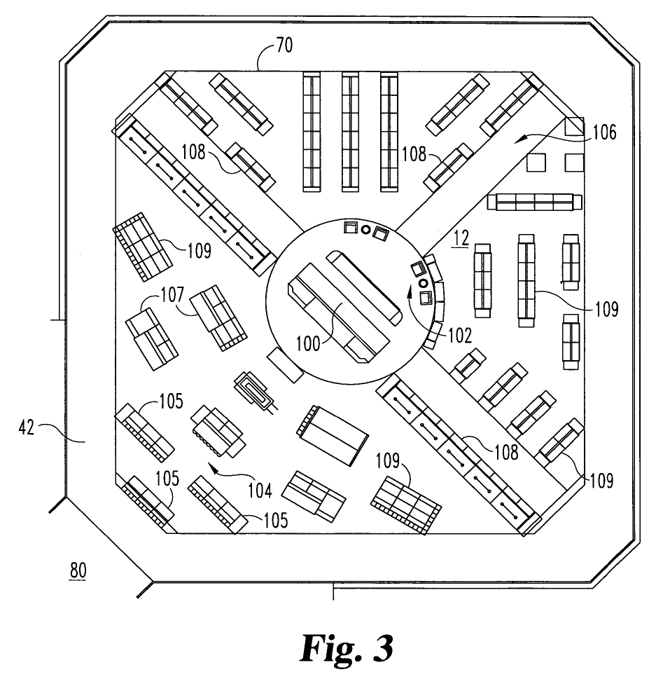

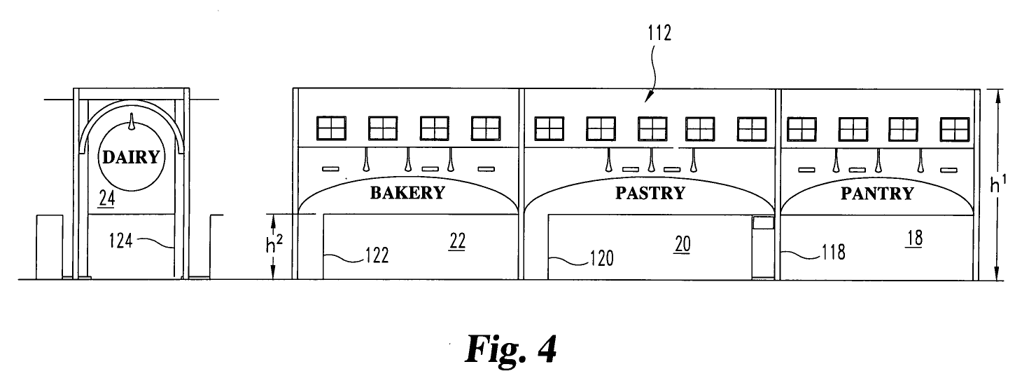

One preferred feature is a logical grouping of merchandise items in a way that is intuitive to the customer. In many respects this logical grouping of merchandise is analogous to the intuitive nature of many Internet web sites which allow an individual to make selections based on intuition and without reference to detailed instructions. To illustrate this point, attention is directed to FIG. 3 and FIG. 4 which show the floor plan and elevation of the central open area 12. FIG. 3 shows a particular layout of merchandise shelves but that other arrangements may be employed with equal success. In addition, the elevational view of FIG. 4 shows the displays removed to provide clarity. Central open area 12 is shown as crossable and having a focal point 100 where customers may rest and enjoy the environment. This focal point 100 may consist of a coffee bar selling a selection of coffees and including a seating area 102 for customers to rest and relax.

One section 104 of open central area 12, herein shown as a diagonal of the area, provides a display for fresh produce. As illustrated, fresh produce area 104 is adjacent the entry 80 so that when a customer comes into the open area 12, they are given the impression of a piazza or European fresh produce market. Within produce area 104, elongated displays 105, 107 and 109, some of which have multiple display levels and may be angled to present various produce items in an appealing manner. As is apparent from FIG. 3, displays 105, 107 and 109 are generally at right angles relative to the customer flow from entry area 80.

The remainder of the open area 12, designated as 106, is given over to specialized merchandise as set out on a plurality of displays 108 and 109. As shown in FIG. 3, the displays 108 and 109 may be oriented in a variety of directions so as to accommodate a particular type of merchandise being displayed. Specifically, the displays 108 are oriented generally in a radial relationship to the center focal point 100 and the displays 109 are oriented generally circumferentially relative to the focal point 100.

FIG. 4 shows an elevation view of the central area 12 in the direction of one interior wall of the building 10 and illustrates several of the principles of the selected embodiment. The central open area has a nominal height h¹ and the individual departments 18 through 24 each have a nominal height, indicated by dashed line 110, of h². The difference in heights h¹ and h² results in a wall 112 that limits the distance a customer can see from any location within the store. If a customer is in an individual department, they can see within that department and into generally the opposite wall of the central open area 12. If a customer is in the central open area 12, the wall they see is wall 112. If one refers to the arrangement of FIGS. 1 and 2, the apparent distance to the furthest wall as observed by the customer is substantially less than the outer perimeter of the building 10. The dimension between walls 112 is less than 50% of the dimensions of a line extending beyond the walls to the outer perimeter of the building at that point. Thus, it is seen that the apparent size of the building is significantly reduced without taking away from the usable floor space for selecting and purchasing merchandise.

Also as shown in FIG. 4, the individual departments can be labeled to indicate to customers from almost anywhere in the store, the location of the individual department. Thus, pantry department 18, pastry department 20, bakery department 22 and dairy department 24 are prominently labeled on the wall 112. The signs are high enough so that they can readily be seen from across the open area 12. The entryway from the departments 18 through 24 to the central area 12 is provided by archways 118 through 124, respectively. This illustrates that there is ready access from the individual departments to the central area and vice-versa.

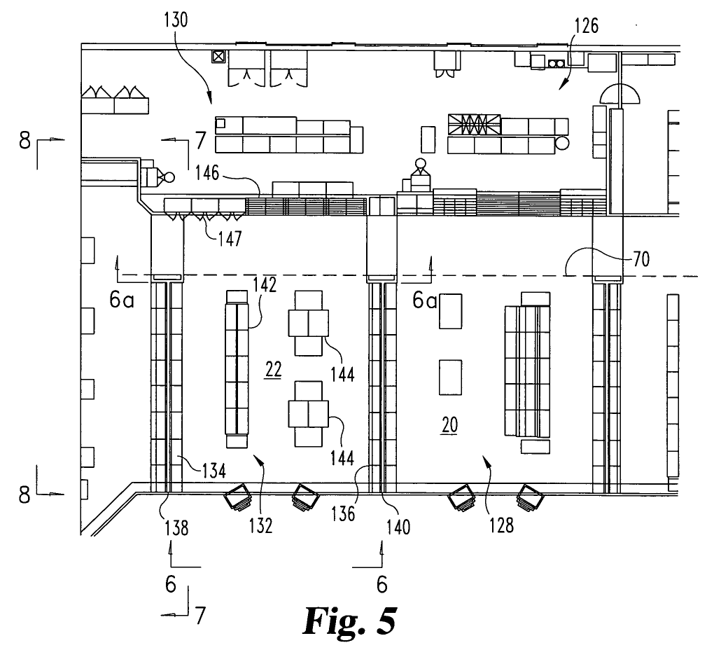

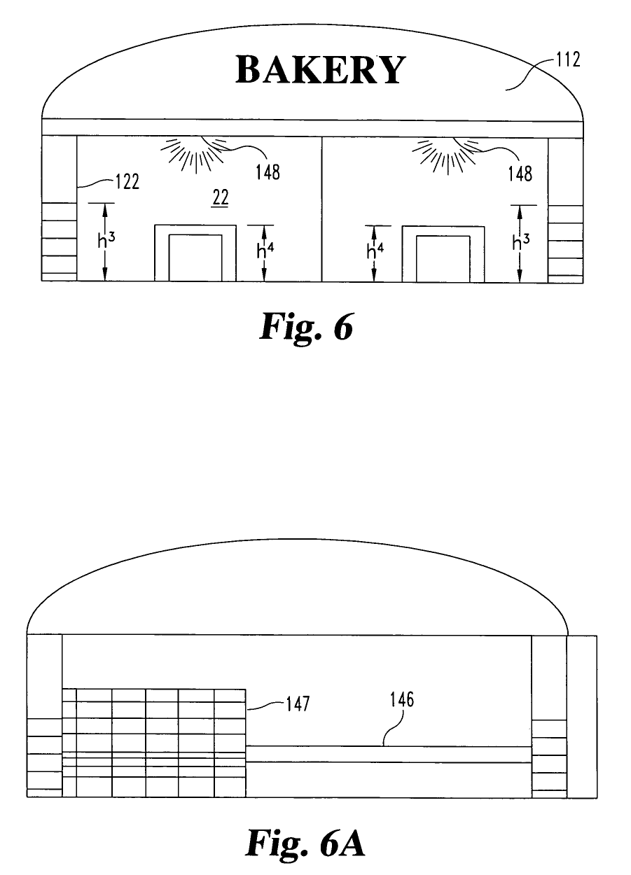

FIG. 5 shows a plan view of adjacent departments 20 and 22 to illustrate configuration and features of individual departments. Departments 20 and 22 are the pastry department and bakery department, respectively. The pastry department 20 is divided into a customer service area 126 and a merchandise display area 128, separated by outer customer path 70. The bakery department 22 is divided into customer service area 130 and merchandise display 132. Merchandise 132 has merchandise display units 134 and 136, also shown in FIG. 6. Merchandise display units 134 and 136 are standard shelf height h³ and are against the walls 138 and 140 of department 22. Center department merchandise display units 142 and 144 are positioned away from walls 138 and 140 and have a height h⁴ significantly lower than the standard height h³ of merchandise display units 134 and 136. A preferred height h⁴ for merchandise units 142 and 144 is 63 inches since it is the average height of eye level for a woman. It should be apparent, however, that other heights may be employed with equal advantage.

Bakery shop 22 also has a customer service area 130 on the other side of customer path 70. The customer service area is demarcated by a counter 146 positioned alongside customer path 70 thus permitting customers to queue in the customer for service within the customer path 70. The bakery shop 22 may have incandescent lighting 148 to introduce a softer, more inviting appearance to the shop. Incandescent lighting is found in other shops as well as in selected locations in other parts of the store 10.

As mentioned previously, the layout of the store preferably provides merchandise groupings in an intuitive pattern. For example, in the bakery 22, the retail area 132 could provide both raw materials for baking such as flour, oil and other ingredients as well as finished bread. When a customer enters into the retail area 132, either from the central open area 12 or the customer path 70, they observe the range of bread products from fresh bread, sliced behind the deli counter, to bread already packaged on the shelf to raw materials. Thus the customer can make an intelligent and real time decision as to which of the stages they desire to buy to achieve the end of having bread on the table. The comparison may lead to a change of decision (i.e. deli sliced bread instead of prepackaged)

The display areas, while grouping merchandise in an intuitive manner, can also be set out in a logical sequence of grocery purchase. For example, the product sales areas may be grouped as follows.
12. Central Area
   100 Coffee bar
   104. Fresh produce
   106. Imported specialty items
14 Deli
16 Snacks and beverages
18 Pantry
20 Pastry
22 Bakery
24 Dairy
26 Seafood
28 Beer
30 Wine
32 Meat
34 Frozen food
36 Body and bath
38 Drug store and pharmacy
40 Baby

Although an example sequence of groups is identified, it should be apparent that other sequences of merchandise grouping can be used with equal benefits for customer traffic flow.

A customer coming to store 10 upon making a right turn can go from department to department in an ordered sequence making selections and collecting merchandise. The placement of the individual merchandise departments around the crossable central open area 12 allows a significant reduction in the distance a customer is required to travel from one department to any other department in the store. This is particularly significant, given the fact that the store itself may be built on a scale of 65,000 sq. ft. The minimization of distance from department to department greatly enhances and makes efficient the shopping experience for time-starved customers who have a minimum of time to obtain goods. On the other hand, a central open area with a resting-place in the center or focal point 100 allows customers to relax and enjoy the ambiance of the store 10.

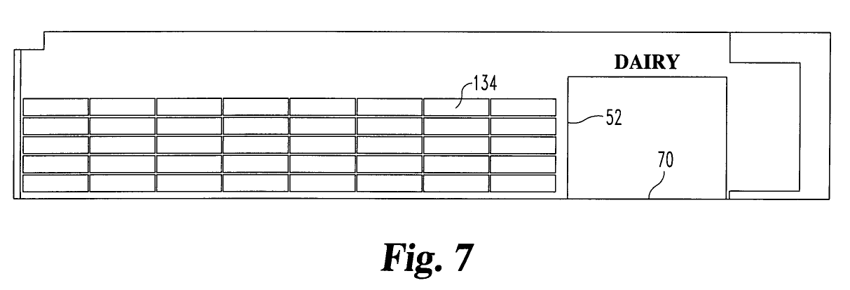

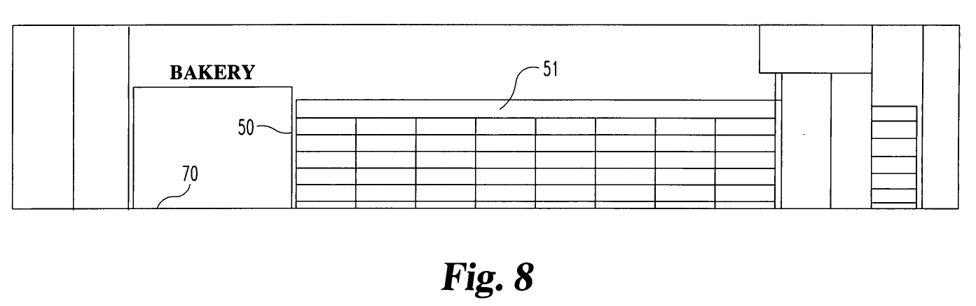

The merchandise departments are preferably laid out and labeled in such a fashion that customers know where they are going and where they have been. Thus, FIG. 6 taken from the open central area 12 shows clearly that the bakery is prominently labeled and can be seen substantially from anywhere in the central open area. FIG. 4 shows the labels or signs for the stores adjacent to the bakery department. FIG. 7 shows the archway 52 leading to the dairy department and the sign prominently above the arch to show that a customer is entering the dairy department along customer path 70. FIG. 8, on the other hand, shows the archway 50 leading from the pastry department 20 to the bakery department 22. It should be apparent that the sign for the bakery department is prominently positioned above the archway 50. Given the intuitive grouping of the merchandise and the prominent signs, the customer should have little trouble navigating through the departments and making thoughtful and efficient decisions about which merchandise to purchase.

The resultant construction and arrangement of the store 10 permits aisles that for the example of a 65,000 sq. ft. store are generally no greater than 30 ft. in length. This eliminates the issues of traversing long aisles up to 100 ft. if customers return for merchandise they have already passed. By optionally providing incandescent lights 148 in the various departments as shown by the example in FIG. 6, a softer, more comfortable and inviting environment is created, thus drawing customers into a relaxed uplifting environment.

Building 10 also preferably has exterior advantages. For example, a traditional “big-box” style building with a high roof across the entire store would normally have a dominant impact on a neighborhood. By making the interior central area 12 at the standard building height for a large store and exterior portions with a lower height, the appearance of the building is one of a smaller structure, thus making it more neighborhood friendly.

In one example embodiment, a grocery store includes outer walls defining a perimeter and a primary consumer entrance. A central area of the store is spaced a distance inward from the store perimeter with the central area defined with a surrounding central peripheral pathway and defining a primary entry direction oriented from the primary consumer entrance towards the central area. Preferably, a plurality of central display stations are located in the central area, where the display stations are arranged substantially obliquely to the entry direction. At least a plurality of display aisles for displaying grocery store related merchandise surround at least portions of the central area, with the display aisles intersecting the peripheral pathway. The intersections are substantially perpendicular. In this example, ceiling elements are over the central area and the display aisles, and the ceiling height over the central area is greater than the ceiling height over the display aisles.

Optionally, the central display stations have at most two flat or forwardly angled display levels configured to display produce. The display aisles may be formed of adjacent shelving units, each shelving unit having a series of shelves. In a feature of certain embodiment, an indirect lighting source is located in the ceiling volume over the central area. One example of an indirect lighting source is windows in transition wall portions defined between the ceiling over the display aisles and the ceiling over the central area. The light sources may be cantilever mounted to and extending outward from the shelving units and arranged to direct light downward and inward towards the shelves.

In one embodiment at least a plurality of display aisles are arranged around the central area in locations substantially opposite the store's primary entrance. Optionally, the display aisles surround at least a majority or at least three quarters of the periphery of the central area. Similarly, the ceiling height over the display aisles may extend at the same height around at least a majority or completely around the central area.

In some embodiments, the display aisles each have a maximum length less than the greatest distance the central area is spaced inward from the store perimeter. In further embodiments, the display aisles each have a maximum length less than one-half the greatest distance the central area is spaced inward from the store perimeter.

In some embodiments the central area is substantially circular or substantially rectangular. In one arrangement the central area is polygonal and the store perimeter is polygonal. Optionally, the primary entrance to the store is defined at a corner of the store perimeter, and the primary entry direction is substantially perpendicular to a side of the central area.

Although specific embodiments have been discussed and emphasized, it should apparent to those skilled in the art that alternative embodiments may be employed while still retaining the spirit and scope of the present invention.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A grocery store for selling grocery store related merchandise to customers, said grocery store comprising:
a central, substantially open area, providing a place for merchandise,
a plurality of merchandise displays positioned in said central open area, at least some of said merchandise displays containing fresh produce,
a plurality of stations for merchandise display surrounding at least a major portion of said central area,
a customer path substantially surrounding said central area on one side of said customer path and interconnecting said merchandise stations on the other side of said customer path for permitting free flow of customers between stations and said central area, and
wherein said central area has a ceiling height greater than the height of said merchandise stations to form elevated walls above said merchandise stations for limiting a customer's sight lines from within said central area to a length less than the outer perimeter of said store.

2. A grocery store as claimed in claim 1 further comprising an elongated entry and exit area, said entry and exit area extending from the exterior of said store to said central open area.

3. A grocery store as claimed in claim 2 wherein said elongated entry and exit area of the store has a ceiling at substantially the same height as that of the central open area.

4. A grocery store as claimed in claim 2 wherein said central open area is rectangular and the elongated entry and exit area of the store is on a diagonal extending to a corner of said central area and through a portion of said customer path.

5. A grocery store as claimed in claim 1 wherein said central area has elongated fresh produce displays located adjacent the intersection of said entry and exit area and said central open area, at least some of said fresh produce displays being oriented to extend at substantially a right angle to the elongated customer path defined by said entry and exit area into said central area.

6. A grocery store as claimed in claim 1 wherein said central area has at least one sign on said elevated walls to indicate the category of the merchandise on display in the merchandise station over which said sign is positioned.

7. A grocery store as claimed in claim 6 wherein said sign indicates merchandise within a category from providing raw materials to make an item, prepackaged items, and fresh items for said category.

8. A grocery store as claimed in claim 1 wherein said central open area has a ceiling and said grocery store further comprises a light source above the level of said merchandise stations in said central open area to illuminate of said central open area.

9. A grocery store as claimed in claim 8 wherein the walls in said central open area have windows adjacent said ceiling for providing said light source from exterior sunlight.

10. A grocery store as claimed in claim 1 wherein at least some of said merchandise stations are departments into which customers can go for merchandise and wherein said store has an outer customer path between adjacent departments.

11. A grocery store as claimed in claim 10 wherein said outer customer path comprises a defined aisle between adjacent departments.

12. A grocery store as claimed in claim 10 wherein said merchandise departments substantially fill the perimeter of said central area and said outer customer path defines a path through said merchandise departments.

13. A grocery store as claimed in claim 10 wherein said outer customer path separates at least one of said merchandise departments into a customer service area and to a customer merchandise area.

14. A grocery store as claimed in claim 10 wherein said outer customer path separates at least one of said departments into merchandise displays on opposite sides of said outer customer path.

15. A grocery store as claimed in claim 10 wherein at least one of said merchandise departments is substantially customer service.

16. A grocery store as claimed in claim 10 wherein each of said departments has a common opening with the adjacent department through which said outer customer path extends and said store further comprises signs on each side of the openings indicating the name of the adjacent department.

17. A grocery store as claimed in claim 10 wherein said merchandise departments have walls and a central area, and said departments further comprise merchandise display units of a standard height positioned along said wall and a second set of merchandise display units positioned away from said wall, said merchandise units being of reduced height relative to the merchandise units on the wall.

18. A grocery store as claimed in claim 1 wherein said central open area is rectangular and the customer entry and exit of said store is at right angle to one of the walls of said central area.

19. A grocery store as claimed in claim 10 wherein said merchandise departments substantially define the outer perimeter of said store and said central area has a maximum dimension that is less than half the maximum outer dimension measured at that part on said store.

20. A grocery store as claimed in claim 10 wherein said central area is substantially a square in plan view and the outer perimeter of said store is substantially a square.

21. A grocery store, comprising:
a grocery store with outer walls defining a perimeter and a primary consumer entrance;
a central area of said store spaced a distance inward from said store perimeter;
said central area defined with a surrounding central peripheral pathway and defining a primary entry direction oriented from said primary consumer entrance towards said central area;
a plurality of central display stations in said central area, wherein said display stations are arranged substantially obliquely to said entry direction,
at least a plurality of display aisles for displaying grocery store related merchandise surrounding at least portions of said central area, wherein said display aisles intersect said peripheral pathway, and wherein said intersections are substantially perpendicular; and,
ceiling elements over said central area and said display aisles, wherein the ceiling height over said central area is greater than the ceiling height over said display aisles.

22. The grocery store of claim 21, wherein said central display stations have at most two flat or forwardly angled display levels configured to display produce.

23. The grocery store of claim 22, wherein said display aisles are formed of adjacent shelving units, each shelving unit having a series of shelves.

24. The grocery store of claim 23, further comprising an indirect lighting source located in the ceiling volume over said central area.

25. The grocery store of claim 24, wherein said indirect lighting source is comprised of windows in transition wall portions defined between the ceiling over said display aisles and the ceiling over said central area.

26. The grocery store of claim 23, further comprising cantilevered light sources mounted to and extending outward from said shelving units and arranged to direct light downward and inward towards said shelves.

27. The grocery store of claim 23, wherein said at least a plurality of display aisles are arranged around said central area in locations substantially opposite said store primary entrance.

28. The grocery store of claim 23, wherein said display aisles surround at least a majority of the periphery of said central area.

29. The grocery store of claim 28, wherein said display aisles surround at least three quarters of the periphery of said central area.

30. The grocery store of claim 23, wherein the ceiling height over said display aisles extends at the same height around at least a majority of said central area.

31. The grocery store of claim 30, wherein the ceiling height over said display aisles extends completely around said central area.

32. The grocery store of claim 30, wherein said display aisles each have a maximum length less than the greatest distance said central area is spaced inward from said store perimeter.

33. The grocery store of claim 32, wherein said display aisles each have a maximum length less than one-half the greatest distance said central area is spaced inward from said store perimeter.

34. The grocery store of claim 23, wherein said central area is substantially circular or substantially rectangular.

35. The grocery store of claim 23, wherein said central area is polygonal, and wherein said store perimeter is polygonal.

36. The grocery store of claim 35, wherein said primary entrance to said store is defined at a corner of said store perimeter.

37. The grocery store of claim 36, wherein said primary entry direction is substantially perpendicular to a side of said central area.
